(19) United States
(12) Patent Application Publication
(10) Pub. No.: US 2020/0086632 A1
(43) Pub. Date: Mar. 19, 2020

(54) METHOD OF CONTROLLING A JETTING DEVICE

(71) Applicant: Océ Holding B.V., Venlo (NL)

(72) Inventor: Herbert MORELISSEN, Venlo (NL)

(73) Assignee: Océ Holding B.V., Venlo (NL)

(21) Appl. No.: 16/571,562

(22) Filed: Sep. 16, 2019

(30) Foreign Application Priority Data
Sep. 17, 2018 (EP) 18194846.4

(51) Int. Cl. B41J 2/045

(52) U.S. Cl. CPC B41J 2/04508; B41J 2/04581

(57) ABSTRACT

In a method of controlling a property of liquid droplets, the droplets are ejected from a jetting device having an array of ejection units, each of which comprises a cavity connected to a nozzle and an actuator associated with the cavity for exciting a pressure wave in the liquid in the cavity. The method includes monitoring a sub-threshold pressure wave oscillating in the cavity, but having an amplitude not large enough for jetting-out a droplet, deriving an indicator for the viscosity of the liquid from the behavior of the sub-threshold pressure wave, and adjusting a setting of the jetting device on the basis of the indicator. The method also includes keeping the array of ejection units at a reference temperature, establishing a reference profile, and establishing an operation profile of the indicator. The setting is adjusted on the basis of a difference between the operation profile and the reference profile, thus eliminating non-temperature related differences between the ejection units.

### CROSS-REFERENCE TO RELATED APPLICATIONS

This application claims priority to European Patent Application No. 18194846.4, filed on Sep. 17, 2018, the entirety of which is expressly incorporated herein by reference.

### BACKGROUND OF THE INVENTION

### 1. Field of the Invention

The invention relates to a method of controlling a property of liquid droplets ejected from a jetting device having an array of ejection units each of which comprises: a cavity connected to a nozzle and an actuator associated with the cavity for exciting a pressure wave in the liquid in the cavity, the method comprising: a step of monitoring a sub-threshold pressure wave oscillating in the cavity but having an amplitude not large enough for jetting-out a droplet, a step of deriving an indicator for the viscosity of the liquid from the behavior of the sub-threshold pressure wave, and a step of adjusting a setting of the jetting device on the basis of the indicator. More particularly, the invention relates to a method of controlling the volume and/or ejection speed of ink droplets ejected from nozzles of an ink jet printer.

### 2. Description of the Related Art

WO 2018/024536 A1 describes a method of this type wherein the actuators in the ejection units, which actuators may for example be constituted by PZT-based piezoelectric transducers, are utilized also as sensors for detecting the sub-threshold pressure waves. These sub-threshold pressure waves may be residual waves that decay in the cavities after each ejection of an ink droplet. As an alternative, the sub-threshold pressure waves may be excited for measurement purposes only, by energizing the actuators with actuation pulses the amplitude of which is so small that no droplets will be ejected.

The decay of the sub-threshold pressure waves can approximately be described by an exponential function with a decay time constant that depends on the amount of damping of the wave and therefore depends critically on the viscosity of the ink. Consequently, the damping time constant can be taken as an indicator for the ink viscosity.

In the known method, this indicator may be utilized for controlling the temperature of the jetting device in order to keep the viscosity of the ink within acceptable limits. Thus, if an analysis of the decaying pressure waves reveals that the viscosity is too high, the temperature is increased in order to decrease the viscosity of the ink. Conversely, the temperature is reduced when the viscosity of the ink turns out to be too low.

As an alternative to actively controlling the ink viscosity via the temperature, it would also be possible to compensate deviations of the ink viscosity from the target value by modifying the waveform of an actuation signal with which the actuator is energized in order to eject an ink droplet. For example, if the viscosity is too high, a sufficient size of the ejected ink droplets may be enforced by increasing the amplitude of the actuation pulses.

It is an object of the invention to provide a method which can improve the uniformity of the performance of the various ejection units in the array, so that the properties (e.g. volume and/or injection speed) of the droplets will be essentially equal for all units in the array.

### SUMMARY OF THE INVENTION

In order to achieve this object, the method according to the invention comprises:
a calibration step in which the array of ejection units is kept at a reference temperature and a reference profile is established by deriving said indicator for a plurality of ejection units; and
a monitoring and control step which is performed in an operating state of the jetting device and comprises establishing an operation profile of said indicator and adjusting said setting of the jetting device on the basis of a difference between the operation profile and the reference profile.

When the jetting device is operating, the actuators of the various ejection units will dissipate heat in proportion to the respective droplet generation frequency. Furthermore, heat may leak from and to the environment, such as from or to a carriage that holds the jetting device. Since this dissipation and/or leakage will in general be different for the different ejection units, the jetting device as a whole must be expected to have a non-uniform temperature distribution, or at least a temperature distribution that is different from the reference temperature. Since the viscosity of the liquid that determines the properties of the ejected droplets is strongly correlated with the temperature, the performance of the various ejection units must also be expected to be non-uniform.

Even when the damping behavior of the pressure waves in the various ejection units is monitored, it is difficult to decide whether the obtained results hint to a uniform performance or to a non-uniform performance of the ejection units. The reason is that the decay behavior of the pressure waves that is taken as indicator for the viscosity of the liquid depends not only on the viscosity of the liquid but also on other factors, including for example the geometries of the cavities and nozzles of the various ejection units, which may differ due to manufacturing tolerances, and the individual properties of the actuators involved. Consequently, even if the indicators obtained for the various ejection units are essentially uniform, this does not necessarily mean that the performance of the ejection units is also uniform. Conversely, if the performance of the ejection units is actually uniform, the distribution of the indicators obtained for the various ejection units may be non-uniform.

The invention solves this problem by performing a reference calibration step in which a reference profile of the indicators is captured under a condition in which the entire jetting device has a reference temperature distribution. Then, when the device is operating and the temperature distribution may have become non-uniform, another profile (operation profile) of the indicator is established and is compared to the reference profile. Then, any local difference between the operation profile and the reference profile can be assumed to be due to a change in temperature, so that suitable measures may be taken to eliminate or compensate that temperature change.

More specific optional features of the invention are indicated in the dependent claims.

In one embodiment, the setting that is adjusted on the basis of the difference between the operation profile and the reference profile may include parameters that determine the waveform of the actuation signals applied to the actuators of the various ejection units. Then, for example, temperature variations may be compensated for by appropriately adjusting the amplitude and/or the steepness of the slopes of the energizing pulses applied to the actuators.

In addition or as an alternative, the settings may comprise settings for local temperature control elements on the jetting device, so that, when the difference between the operation profile and the reference profile hints to spatial temperature fluctuations, the jetting device may be heated or cooled locally so as to re-establish a uniform temperature distribution. One way of locally heating is by applying non-jetting actuation of the actuators. In comparison to measuring a temperature profile with temperature sensors, the method according to the invention has the advantage that it is sensitive to the condition of the liquid directly in the cavities, so that any changes can be detected without delay.

### BRIEF DESCRIPTION OF THE DRAWINGS

Embodiment examples will now be described in conjunction with the drawings, wherein:

FIG. 1 is a cross-sectional view of mechanical parts of a droplet ejection unit, together with an electronic circuit for controlling and monitoring the unit;

FIG. 2 shows examples of waveforms of an energizing signal applied to an actuator of an ejection unit;

FIG. 3 is a time chart illustrating a decaying pressure wave in a cavity of an ejection unit;

FIG. 4 is a perspective view of a part of a jetting device having a plurality of ejection units that constitute a linear array;

FIG. 5 is a flow chart illustrating essential steps of a method according to the invention; and

FIG. 6 shows examples of a reference profile and an operation profile of an indicator for the viscosity of a liquid jetted out by the various ejection units of the jetting device.

### DETAILED DESCRIPTION OF EMBODIMENTS

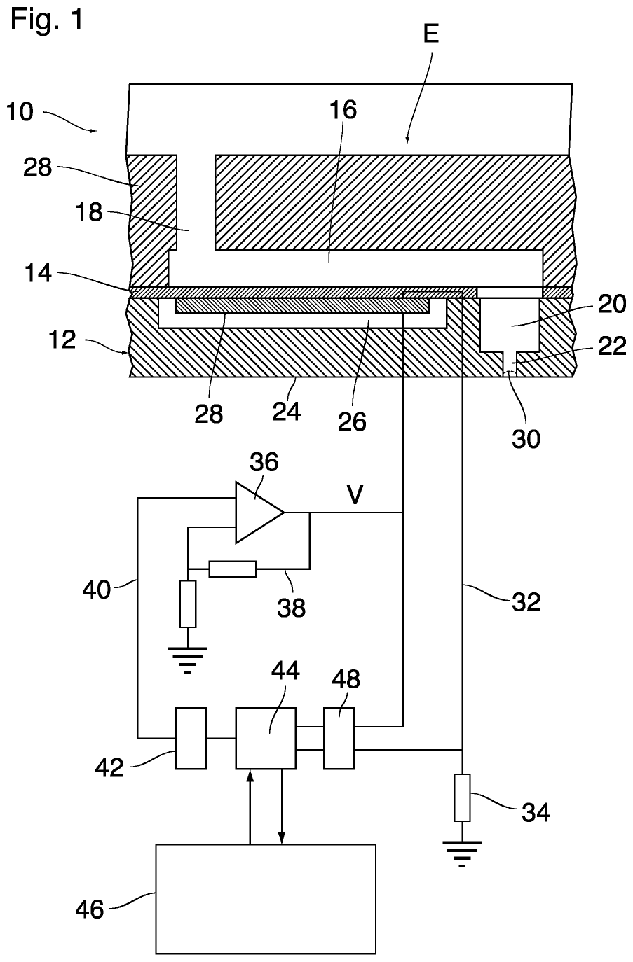

FIG. 1 shows a single ejection unit E of an ink jet print head, the print head being an example of a droplet ejection device. The device comprises a wafer 10 and a support member 12 that are bonded to opposite sides of a thin flexible membrane 14.

A recess that forms an ink duct 16 is formed in the face of the wafer 10 that engages the membrane 14, i.e. the bottom face in FIG. 1. The ink duct 16 has an essentially rectangular shape. An end portion on the left side in FIG. 1 is connected to an ink supply line 18 that passes through the wafer 10 in thickness direction of the wafer and serves for supplying liquid ink to the ink duct 16.

An opposite end of the ink duct 16, on the right side in FIG. 1, is connected, through an opening in the membrane 14, to a chamber 20 that is formed in the support member 12 and opens-out into a nozzle 22 that is formed in a nozzle face 24 constituting the bottom face of the support member 12. Together, the ink duct 16 and the chamber 20 for a cavity that is filled with ink.

Adjacent to the membrane 14 and separated from the chamber 20, the support member 12 forms another cavity 26 accommodating a piezoelectric actuator 28 that is bonded to the membrane 14.

An ink supply system which has not been shown here keeps the pressure of the liquid ink in the cavity 16, 20 the slightly below the atmospheric pressure, so as to prevent the ink from leaking out through the nozzle 22. Thus, the ink forms a meniscus 30 inside the nozzle 22.

The piezoelectric actuator 28 has electrodes that are connected to an electronic circuit that has been shown in the lower part of FIG. 1. In the example shown, one electrode of the actuator is grounded via a line 32 and a resistor 34. Another electrode of the actuator is connected to an output of an amplifier 36 that is feedback-controlled via a feedback network 38, so that a voltage V applied to the transducer will be proportional to a signal on an input line 40 of the amplifier. The signal on the input line 40 is generated by a D/A-converter 42 that receives a digital input from a local digital controller 44. The controller 44 is connected to a processor 46.

When an ink droplet is to be expelled from the nozzle 22, the processor 46 sends a command to the controller 44 which outputs a digital signal that causes the D/A-converter 42 and the amplifier 36 to apply a voltage pulse to the actuator 28. This voltage pulse causes the actuator to deform in a bending mode. More specifically, the actuator 28 is caused to flex downward, so that the membrane 14 which is bonded to the transducer 28 will also flex downward, thereby to increase the volume of the ink duct 16. As a consequence, additional ink will be sucked-in via the supply line 18. Then, when the voltage pulse falls off again, the membrane 14 will flex back into the original state, so that a positive acoustic pressure wave is generated in the liquid ink in the duct 16. This pressure wave propagates to the nozzle 22 and causes an ink droplet to be expelled.

The electrodes of the transducer 28 are also connected to an A/D converter 48 which measures a voltage drop across the transducer and also a voltage drop across the resistor 34 and thereby implicitly the current flowing through the transducer. Corresponding digital signals are forwarded to the controller 44 which can derive the impedance of the transducer 28 from these signals. The measured electric response (current, voltage, impedance, etc.) is signaled to the processor 46 where the electric response is processed further.

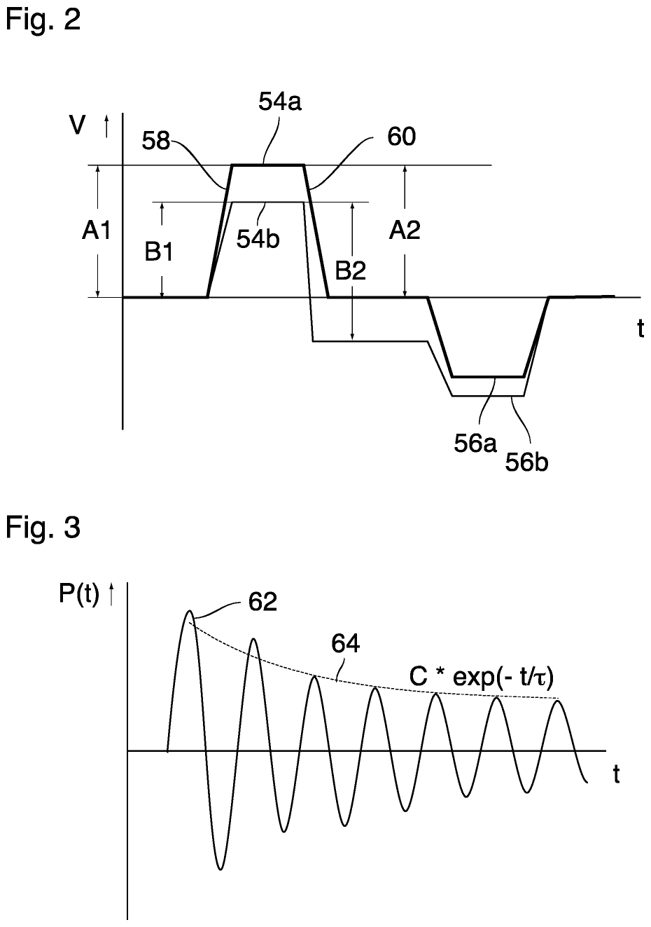

FIG. 2 shows the voltage V (in arbitrary units) applied to the actuator 28 as a function of the time t.

When an ink droplet is to be expelled from the nozzle, the actuator 28 is at first energized with an actuation pulse 54a with positive polarity, and then, after a certain delay time, with a quench pulse 56a which has negative polarity and a somewhat smaller amplitude. As an alternative, a quench pulse with a positive polarity may be used, this quench pulse being somewhat later in time than the one showed in FIG. 2. This alternative quench pulse is only applicable if sufficient time is available. The actuation pulse 54a has a rising flank 58 with a height A1, and a descending flank 60 with a height A2. In case of the actuation pulse 54a shown in continuous lines in FIG. 2, the pulse has a symmetric shape, so that A1=A2. During the rising flank 58 of the actuation pulse, the membrane 14 is flexed downwardly in FIG. 1, so that fresh ink is drawn in from the ink supply line 18. Then, during the descending flank 60, the membrane 14 moves upwards again, so that the volume of the ink duct 16 is reduced and a pressure wave is excited in the liquid ink. This pressure wave will propagate to the nozzle 22 and will cause an ink droplet to be expelled. While the droplet is being jetting out, the pressure wave is reflected (with phase reversal) at the meniscus 30 and will propagate back into the ink duct 16 at the end of which it will be reflected again, so that the ink in the ink duct 16 undergoes periodic pressure fluctuations which gradually decay in the course of time before a next droplet is to be ejected.

The quench pulse 56a is timed and dimensioned so as to attenuate the pressure fluctuations by destructive interference, so that the fluctuations may be reduced to practically zero before the next ink droplet is to be ejected.

FIG. 2 further shows (in fainter lines) a modified waveform of the voltage V, with an actuation pulse 54b and a quench pulse 56b. In this waveform, the actuation pulse 54b has a smaller amplitude B1, and the descending flank has a height B2 that is different from B1. Further, this flank is steeper than the flank of the actuation pulse 54a. The amplitude of the actuation pulses, a possible height difference between the rising flank and the descending flank, and the steepness of the descending flank are examples for parameters that may be varied in order to influence the volume and the ejection speed of the ink droplets being ejected. In particular, these parameters may be varied in order to compensate for any possible changes in the viscosity of the ink.

If the amplitude of the actuation pulse is reduced further, the amplitude of the resulting pressure wave in the ink will remain below a certain threshold that is necessary for ejecting an ink droplet. Instead, the pressure wave will only move the meniscus 30 in the nozzle 22. Such a sub-threshold pressure wave may be generated on purpose in order to obtain an indicator for the viscosity of the liquid. When the printer is operating, a sub-threshold pressure wave may also be obtained in the form of a residual pressure fluctuation after the ejection of a droplet. In the example described here, it shall however be assumed that the sub-threshold pressure wave is generated on purpose by exciting the transducer 28 with an actuation pulse with sufficiently small amplitude.

FIG. 3 shows a typical waveform of such a sub-threshold pressure wave 62 decaying in the ink duct 16, the pressure wave being represented by a function P(t) of the time t. The electronic circuit shown in FIG. 1 is capable of measuring the response of the transducer 28 to the corresponding pressure fluctuations, so that the processor 46 may record and analyze the function P(t). Note that in practice, the extinction of the oscillation is much stronger, but for illustration purposes a large number of oscillations are shown.

As is shown in FIG. 3, at least a tail part of the pressure fluctuation (leaving out the first two wave crests) has an envelope 24 that can be expressed in good approximation by an exponential function C*exp (−t/τ), wherein C is an initial amplitude that is determined by the height of the actuation pulse, and τ is a damping time constant that depends critically upon the viscosity of the ink and can therefore be utilized as an indicator for the ink viscosity.

Although the information provided by the indicator or damping time constant τ may not be sufficient for deriving an absolute value of the ink viscosity, it is possible to detect any changes in the viscosity by monitoring the indicator τ as determined by the processor 46. An even more accurate indicator is the ratio of the oscillation time T and the damping time constant τ. It will be understood that the indicator T/τ may be derived from P(t) in a similar way as τ itself and be used as indicator for deriving changes in the viscosity.

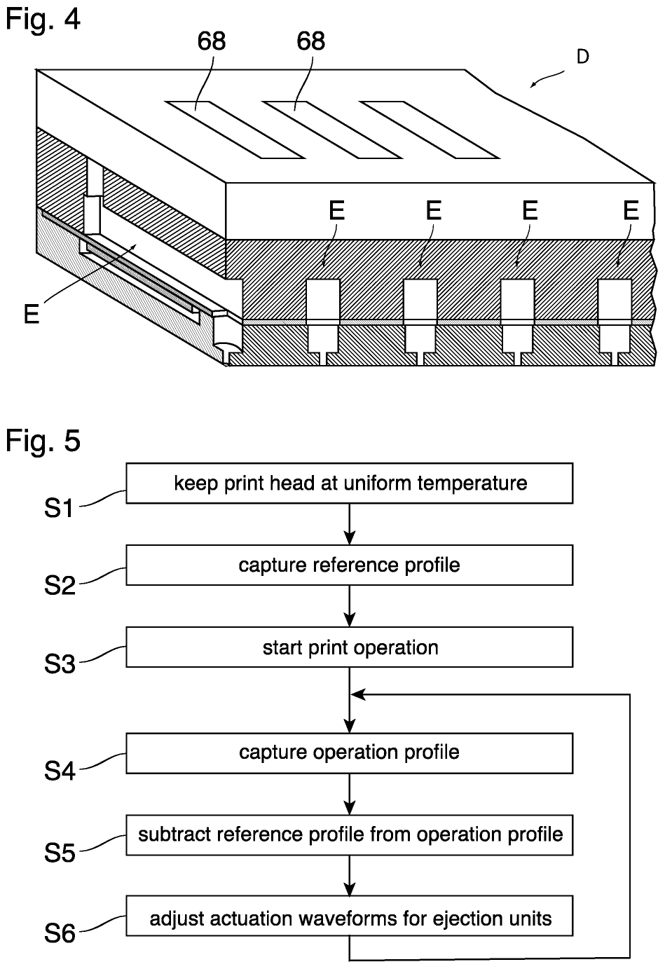

FIG. 4 is a perspective view, partly in section, of a larger part of a jetting device (printer) D that comprises a plurality of ejection units E arranged in a linear array. The electronic circuits (FIG. 1) of the plurality of ejection units E may share a common processor 46 for capturing the indicators τ in the different ejection units one after the other.

Even if the viscosity of the ink is the same in all these units, the indicators τ derived from the pressure waves in the different units may differ from one another due to slightly different geometries of the ink ducts and nozzles, differences in a strain and flexibility of the membrane 14, and the like. When the printer is operating, it may depend upon the image contents to be printed how often the different ejection units are activated. Consequently, there may be local differences in the amount of heat dissipated by the actuators 28, so that the ejection device D as a whole may have a non-uniform temperature profile, or at least a temperature distribution deviating from the reference temperature, and, since the viscosity of the ink is temperature-dependent, the viscosities of the ink in the different ejection units E may be different, which will also be reflected by the indicators T. Furthermore, heat to or from the environment may influence the temperature distribution over the jetting device.

Ideally, the jetting device D will be configured such that, when its temperature profile is uniform, all ejection units E have the same performance, i.e. they all produce ink droplets which have the same volume and are jetted out with the same speed, so that the printed image will not be affected by non-uniformities in the droplet side nor by non-uniformities in the droplet speed (given that the print head moves relative to the recording medium). In practice, there may however be slight differences in the performance of the ejection units E even under uniform temperature conditions. If necessary, these differences can be eliminated by suitably adapting the settings for the waveforms of the actuation voltage V individually for each ejection unit.

However, if the printer has been operating for a certain time, the above-mentioned differences in the heat dissipation may lead to a non-uniform temperature profile and, consequently, a non-uniform performance of the ejection units.

FIG. 5 is a flow diagram showing major steps of a method for detecting and, if necessary, eliminating such temperature-induced non-uniformities.

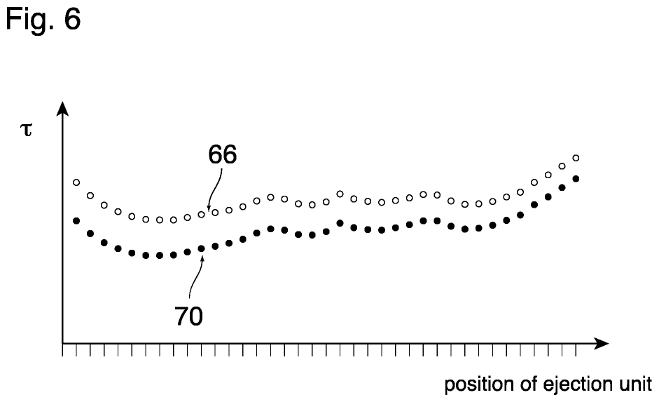

In step S1, the entire jetting device D is kept in an environment with a constant and uniform temperature for a time period sufficiently long to assure that the entire body of the jetting device will have a uniform temperature. Then, in step S2, the sub-threshold pressure waves are excited in all or at least some of the ejection units E that are evenly distributed over the linear array, and the indicators τ obtained for the different ejection units are combined to form a reference profile of the indicators τ. This reference profile is determined at a production time of the device and stored for future use. An example of such a reference profile has been shown in FIG. 6 and designated as 66. The positions of the ejection units E in the linear array are given on the horizontal axis, and the indicators τ obtained for the various ejection units are given on the vertical axis (in arbitrary units). It can be seen that, although the ink in all ejection units has the same temperature and should therefore also have the same viscosity, the indicators τ are not exactly equal.

Optionally, as is shown in FIG. 4, the body of the jetting device D may have a plurality of temperature sensors 68 evenly distributed over the length of the array of injection units, so that the temperature distribution in the jetting device can be measured in order to verify that a uniform temperature profile has actually been reached in step S1.

When the reference profile 66 has been captured in step S2, the jetting device starts operating in step S3, which may result in changes in the temperature profile of the device.

Then, in step S4, an operation profile 70 of the indicators τ is captured, as has also been shown in FIG. 6. It can be seen that the operation profile 70 is different from the reference profile 66, due to a change in the temperature distribution of the jetting device. If the temperature distribution in the jetting device would still be uniform when the operation profile 70 is captured, it should be expected that the operation profile 70 has the same shape as the reference profile 66 and is only shifted along the vertical axis. However, in the example shown in FIG. 6, the difference between the operation profile 70 and the reference profile 66 is larger on the left side in FIG. 6 (first end of the array) than on the right side (opposite end of the array). This permits to conclude that the temperature distribution in the jetting device is no longer uniform but that there is a certain temperature gradient from end of the array to the other.

For each of the ejection units that form part of the profiles shown in FIG. 6, the difference between the reference profile 66 and the operation profile 70 can be interpreted as a change in the viscosity of the ink (because all other factors that may influence the indicator τ have not changed).

Returning to FIG. 5, in order to detect and possibly correct a non-uniform temperature distribution in the jetting device, the reference profile 66 is subtracted from the operation profile 70 in step S5. Then, the difference obtained for an individual ejection unit E may be interpreted as a change in viscosity. The effect on the volume and ejection speed of the ink droplets may be calculated based on a known relation between viscosity and drop size on the one hand and viscosity and ejection speed on the other hand. Then, in step S6, the parameters defining the waveforms of the actuation voltage V in FIG. 2 are adapted so as to return the drop size and the ejection speed to their target values. It will be understood that this step is performed individually for each ejection unit E, so that a uniform performance of the device is obtained.

The steps S4-S6 are repeated in certain intervals in order to compensate any possible changes of the temperature profile over time.

In a modified embodiment, the temperature sensors 68 shown in FIG. 4 may be configured as combined temperature sensing and control elements capable of actively heating (and/or cooling) the jetting device. In that case, the step S6 may be complemented by a step of adjusting the heating power of the temperature sensing and control elements in order to re-establish a uniform temperature profile.

It will be understood that these two embodiments may also be combined, for example by adjusting the waveforms as a quick response to changes in the temperature profile, and adjusting the temperature profile itself for long-term stability.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method of controlling a property of liquid droplets ejected from a jetting device, having an array of ejection units each of which comprises a cavity connected to a nozzle and an actuator associated with the cavity for exciting a pressure wave in the liquid in the cavity, the method comprising the steps of:
monitoring a sub-threshold pressure wave oscillating in the cavity, the pressure wave having an amplitude not large enough for jetting-out a droplet;
deriving an indicator for the viscosity of the liquid from the behavior of the sub-threshold pressure wave; and
adjusting a setting of the jetting device on the basis of the indicator,
wherein a reference calibration is made in which the array of ejection units is kept at a reference temperature and a reference profile is established by deriving said indicator for a plurality of ejection units,
wherein a monitoring and control step is performed in an operating state of the jetting device, establishing an operation profile of said indicator, and
wherein said setting is adjusted on the basis of a difference between the operation profile and the reference profile.

2. The method according to claim 1, wherein said monitoring and control step includes adjusting waveforms of actuation voltages to be applied to the actuators of the individual ejection units.

3. The method according to claim 1, wherein said monitoring and control step comprises adjusting a temperature profile of the jetting device.

4. The method according to claim 1, wherein the actuators in the ejection units are utilized as sensors for monitoring the sub-threshold pressure waves in the individual ejection units.

5. The method according to claim 1, wherein said indicator is a decay time constant of the sub-threshold pressure wave decaying in the cavity.

6. The method according to claim 1, wherein the jetting device is an ink jet printer.

7. A jetting device having an array of ejection units, each of the ejection units comprising:
a cavity connected to a nozzle; and
an actuator associated with a cavity for exciting a pressure wave in the liquid in the cavity,
wherein the jetting device is configured to perform the method according to claim 1.
